(19) United States
(12) Patent Application Publication
(10) Pub. No.: US 2015/0031529 A1
(43) Pub. Date: Jan. 29, 2015

(54) CATALYST UNIT

(71) Applicant: Hyundai Motor Company, Seoul (KR)

(72) Inventor: Sungmu CHOI, Seongnam-si (KR)

(73) Assignee: Hyundai Motor Company, Seoul (KR)

(21) Appl. No.: 14/512,728

(22) Filed: Oct. 13, 2014

Related U.S. Application Data
(62) Division of application No. 13/303,548, filed on Nov. 23, 2011.

(30) Foreign Application Priority Data
May 13, 2011 (KR) 10-2011-0045173

(51) Int. Cl. B01J 37/02; B01J 35/04

(52) U.S. Cl. CPC B01J 37/0228; B01J 35/04
USPC 502/300

(57) ABSTRACT

A catalyst unit may include a first brick having a first noble metal layer formed along an exhaust gas passage thereof and being disposed on a space that an exhaust gas flow rate may be a predetermined rate, a second brick being disposed onto the first brick and having a second noble metal layer formed along an exhaust gas passage thereof, wherein the second brick may be disposed on a space that an exhaust gas flow rate may be lower than the predetermined rate, and wherein the first brick and the second brick may be attached together to fix the second brick onto the first brick.

### CROSS-REFERENCE TO RELATED APPLICATION

The present application claims priority to Korean Patent Application No. 10-2011-0045173 filed in the Korean Intellectual Property Office on May 13, 2011, the entire contents of which is incorporated herein for all purposes by this reference.

### BACKGROUND OF THE INVENTION

1. Field of the Invention

The present invention relates to a catalyst unit that includes catalyst ingredients to reduce harmful materials of exhaust gas according to a flow characteristic.

2. Description of Related Art

In a vehicle, a three way catalyst converter is generally used to purify exhaust gas, which is disposed on an exhaust pipe, and the specifications thereof are different, because exhaust gas flow rates are different according to vehicles.

The three way catalytic converter simultaneously reacts harmful materials of exhaust gas such as carbon monoxide, nitrogen oxide, and hydrocarbon compound to eliminate these materials, and mainly Pt/Rh, Pd/Rh or Pt/Pd/Rh series is formed in the three way catalytic converter.

Meanwhile, a diesel vehicle that generates large amount of noxious exhaust gas is excellent in a fuel consumption efficiency and a power output, but nitrogen oxide and PM (particulate matters) are heavily included therein in contrast to a gasoline vehicle.

In the diesel vehicle like this, because intake air is sufficiently combusted in the most of driving condition, carbon monoxide and hydrocarbon is very little compared to the gasoline vehicle and nitrogen oxide and PM is heavily exhausted.

Recently, as a post process art, a diesel particulate filter research is very actively being undergone so as to correspond to the reinforced exhaust gas standard of the diesel vehicle, and there are many parts that are to be developed so as to apply the diesel particulate filter to a real vehicle.

Platinum is used in a coating layer of a Diesel Oxidation Catalyst (DOC), separately, Diesel Particulate Filter (DPF) is applied to a system of DOC+DPF, and CPF, which is recently being mass produced in an EU vehicle maker, and the reliability thereof increased the sales of the system.

And, a diesel particulate filter that a catalyst is coated thereon, which is called a diesel catalyzed particulate filter, has been developed. Meanwhile, several methods have been widely known for coating different kinds of catalyst on a cordierite carrier, and there are many prior arts.

For example, there is a dipping method that a cordierite carrier is dipped into catalyst solutions respectively having different concentrations and there is a suction method that one end side of a carrier is dipped into a catalyst solution and a vacuum pressure is formed in the other end side of the carrier to suck the catalyst solution through channels of the carrier.

However, these methods can be applied to a wall flow type of a carrier, and more particularly, different kinds coatings can be only applied to a carrier having the wall flow type, wherein CO or HC flows into an inlet of a channel of the carrier to get out of the outlet thereof.

Whereas, a diesel particulate filter (DPF) has a structure that is different from that of a conventional cordierite carrier. More particularly, one side of each cell is opened and the other side thereof is closed so as to filter soot in exhaust gas, wherein the soot is filtered by wall and the exhaust gas goes through the wall.

Accordingly, as material of the filter, SiC that is durable in a high temperature is used.

However, since the filter that is made up of the SiC material has a high heat expansion rate, in a case that the filter is manufactured to become a real size, the filter can be cracked by a heat expansion.

Accordingly, when the filter is made up of SiC material, each segment is made in advance, and the segment is assembled to a real size filter through cement.

However, since one end of each cell is plugged in the diesel particulate filter, it is impossible to coat catalyst in a sucking method that one side of the filter is dipped into the catalyst solution and the vacuum is applied to the other side thereof so as to suck the solution.

And, when a different concentration catalyst is to be coated, the suction device cannot be applied thereto and only the dipping method can be applied.

However, the dipping method can coat the different catalyst based on a length direction of the filter and cannot coat the different catalyst based on a section thereof.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide a catalyst unit having advantages of improving purification efficiency of exhaust gas by forming different catalyst layer along the sectional direction that is related to the purification rate of the exhaust gas according to the flow pattern of the exhaust gas.

Further, various aspects of the present invention are directed to provide a catalyst unit having a different shape according to the flow characteristic of the exhaust gas.

In an aspect of the present invention, a catalyst unit may include a first brick having a first noble metal layer formed along an exhaust gas passage thereof and being disposed on a space that an exhaust gas flow rate is a predetermined rate, a second brick being disposed onto the first brick and having a second noble metal layer formed along an exhaust gas passage thereof, wherein the second brick is disposed on a space that an exhaust gas flow rate is lower than the predetermined rate, and wherein the first brick and the second brick are attached together to fix the second brick onto the first brick.

Exhaust gas holes are formed in the first brick and the second brick.

A hole is formed in the center along a longitudinal direction of the second brick to form a shape of a cylindrical pipe, wherein the first brick is inserted into the hole of the second brick and fixed there to.

The first brick is disposed onto an upper surface of the second brick, wherein a lower surface of the first brick and the upper surface of the second brick may have a curved line surface, wherein a central portion of the lower surface in the first brick is plane and both side edges thereof are slanted upwards and a central portion of the upper surface of the second brick is plane corresponding to the lower surface of the first brick and both sides edges thereof are slanted upwards.

A sectional shape of the first brick and the second brick are asymmetrically formed according to the exhaust gas flow rates.

The first brick or the second brick may include a cordierite (2MgO₂Al₂O₃5SiO₂), wherein the first brick and the second brick are attached by a cordierite cement.

The catalyst unit including the first brick and the second brick is applied to a catalytic converter that an outlet and an inlet thereof are opened.

In another aspect of the present invention, a manufacturing method of a catalyst unit, may include extruding a first brick that exhaust gas holes are formed therein, extruding a second brick that exhaust gas holes are formed therein, forming a first noble metal layer in the first brick, forming a second noble metal layer in the second brick, and attaching the first brick on the second brick.

The second brick may have a hole formed in the center along a longitudinal direction of the second brick to form a shape of a cylindrical pipe, wherein the first brick is inserted into the hole of the second brick and fixed there to.

The first brick is disposed onto an upper surface of the second brick, wherein a lower surface of the first brick and the upper surface of the second brick may have a curved line surface, and wherein a central portion of the lower surface in the first brick is plane and both side edges thereof are slanted upwards and a central portion of the upper surface of the second brick is plane corresponding to the lower surface of the first brick and both sides edges thereof are slanted upwards.

As stated above, a first brick that a high noble metal layer is formed is disposed on a portion that the exhaust gas flow rate is high and a second brick that a low noble metal layer is formed is disposed on a portion that the exhaust gas flow rate is low such that the noble metal can be saved and the purification efficiency thereof is improved in the catalyst unit according to an exemplary embodiment of the present invention.

Also, the shape of the first brick and the second brick are differently formed along the flow pattern of the exhaust gas to be able to actively correspond to the flow pattern of the exhaust gas and the catalyst layer is easily formed by sucking wash coat solution through the inlet and the outlet of the flow through type catalyst unit.

### BRIEF DESCRIPTION OF THE DRAWINGS

FIG. 1 is a perspective view showing an assembly procedure of a catalyst unit according to an exemplary embodiment of the present invention.

FIG. 2 is a perspective view showing an assembly procedure of a catalyst unit according to another exemplary embodiment of the present invention.

FIG. 3 is a graph showing effects of a catalyst unit according to an exemplary embodiment of the present invention.

FIG. 4 is a flowchart showing a manufacturing procedure of a catalyst unit according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

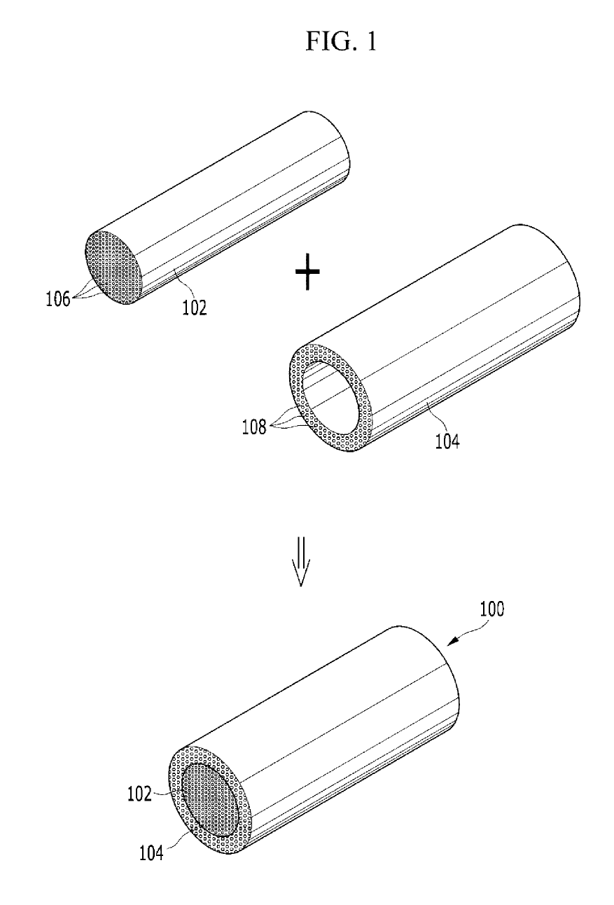

FIG. 1 is a perspective view showing an assembly procedure of a catalyst unit according to an exemplary embodiment of the present invention.

Referring to FIG. 1, a catalyst unit 100 includes a first brick 102 and a second brick 104.

Exhaust gas holes 106 that exhaust gas flows are formed from a front side to a rear side of the first brick 102 and exhaust gas holes 106 that exhaust gas flows are formed from a front side to a rear side of the second brick 108.

The first brick 102 and the second brick 104 are flow through types that plugs are not formed in the inlet and the outlet of the exhaust gas hole 106 and 108. The flow through type is applied to an oxidation catalyst, a diesel oxidation catalyst, or a gasoline three way convertor.

As shown, the second brick 104 has a cylindrical pipe structure, a hole is formed along a central portion of a length direction, and the first brick 102 is inserted into the hole.

An exterior circumference of the first brick 102 and the interior circumference of the second brick 104 contact each other, and the bonding material can be between them. The first brick 102 and the second brick 104 are made up of cordierite and the bonding material can be a cordierite cement.

Coating layer is formed respectively in the first brick 102 and the second brick 104. In an exemplary embodiment of the present invention, high noble metal layer is formed in the first brick 102 and low noble metal layer is formed in the second brick 104.

More particularly, large amount of exhaust gas flows through the first brick 102, and small amount of exhaust gas flows through the second brick 104. Accordingly, high noble metal layer that large amount of catalyst is applied is formed in the first brick 102 and low noble metal layer that small amount of catalyst is applied is formed in the second brick 104.

The high noble metal layer is uniformly formed in the first brick 102 and the low noble metal layer is uniformly formed in the second brick 104.

Accordingly, the high noble metal layer is formed in the first brick 102 that the exhaust gas flow is high and the low noble metal layer is formed in the second brick 104 that the exhaust gas flow is low such that the purification efficiency of the exhaust gas is improved and the noble metal is efficiently used to save the production cost thereof.

In a FIG. 1, sectional shapes of the first brick 102 and the second brick 104 are symmetrical and the symmetrical structure can be applied to an under floor catalytic converter (UCC) or a diesel particulate filter (DPF).

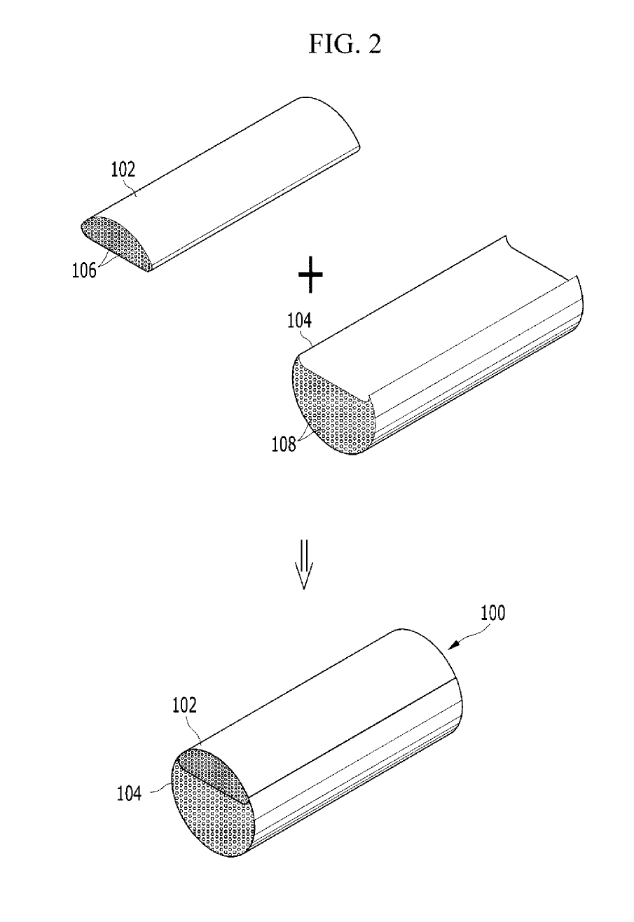

FIG. 2 is a perspective view showing an assembly procedure of a catalyst unit according to another exemplary embodiment of the present invention.

A detailed description of the same or similar construction to FIG. 1 will be omitted and a different construction will be described in FIG. 2.

Referring to FIG. 2, the first brick 102 and the second brick 104 are formed in a direction that the exhaust gas flows, wherein the first brick 102 is formed at a central portion of an upper side and the second brick 104 contacts a lower surface of the first brick 102 to be fixed thereon.

The central portion of the lower surface of the first brick 102 is plane and the both side edges thereof are slanted in an upper side. Further, the central portion of the upper surface of the second brick 104 is plane corresponding to the lower surface of the first brick 102 and the both sides edges thereof are slanted in an upper side.

The first brick 102 is disposed in a portion that the exhaust gas flow is high and the second brick 104 is disposed in a portion that the exhaust gas flow is low. In an exemplary embodiment of the present invention, the sectional shape of the first brick 102 and the second brick 104 are determined by the flow rate of the exhaust gas.

More particularly, the contact surface that the first brick 102 and the second brick 104 contact has a curbed line type, wherein the contact surface is formed by the exhaust gas flow amount/rate. Accordingly, the sectional shape of the first brick 102 and the second brick 104 can be freely formed by a process extruding cordierite material.

The lower surface of the first brick 102 and the upper surface of the second brick 104 contacts to each other, and the bonding material can be interposed therebetween. The first brick 102 and the second brick 104 are made up of cordierite and the bonding material that fixes the first brick 102 on the second brick 104 can be made up of cordierite.

Catalyst layer is respectively formed in the first brick 102 and the second brick 104. In an exemplary embodiment of the present invention, the high noble metal layer is formed in the first brick 102 and the low noble metal layer is formed in the second brick 104.

More particularly, the flow rate of the exhaust gas is high through the first brick 102 and the flow rate of the exhaust gas is low through the second brick 104. Accordingly, the high noble metal layer that the catalyst amount is high is formed in the first brick 102 and the low noble metal layer that the catalyst amount is low is formed in the second brick 104.

The high noble metal layer is uniformly formed in the first brick 102 and the low noble metal layer is uniformly formed in the second brick 104. Accordingly, the high noble metal layer is formed in the first brick 102 that the exhaust gas flow is high and the low noble metal layer is formed in the second brick 104 that the exhaust gas flow is low such that the purification efficiency of the exhaust gas is improved and the noble metal is efficiently used to save the production cost thereof.

In the FIG. 2, sectional shapes of the first brick 102 and the second brick 104 are asymmetrical and the asymmetrical structure can be applied to an closed catalytic converter (CCC).

Referring to FIG. 1 and FIG. 2, forming the high noble metal layer and the low noble metal layer in the first brick 102 and the second brick 104 can be achieved by a sucking method that one side of the filter is dipped into the catalyst solution (wash coat) and vacuum is formed in the other side thereof to suck the catalyst solution.

Further, in an exemplary embodiment of the present invention, the high noble metal layer of the first brick 102 and the low noble metal layer of the second brick 104 can have different catalyst elements from each other. More particularly, a first noble metal layer is formed in the first brick 102 and a second noble metal layer is formed in the second brick 104, wherein the first noble metal element is different from the second noble metal elements.

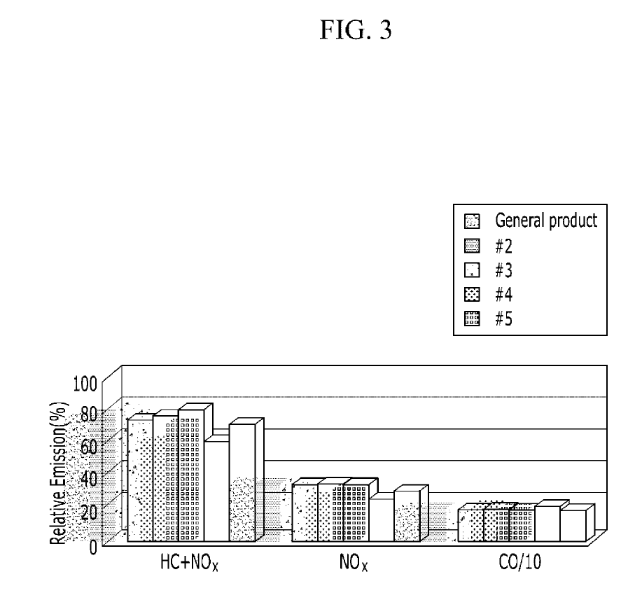

FIG. 3 is a graph showing effects of a catalyst unit according to an exemplary embodiment of the present invention.

Referring to FIG. 3, a horizontal axis denotes a hydrocarbon(HC), a nitrogen oxide (NOx) and a carbon monoxide(CO) that are included in exhaust gas, and a vertical axis denotes a relative amount (%).

As shown, among products that are made according to an exemplary embodiment of the present invention, a product #4 shows that the amount of hydrocarbon and nitrogen oxide decreases as much as about 18% to 29%.

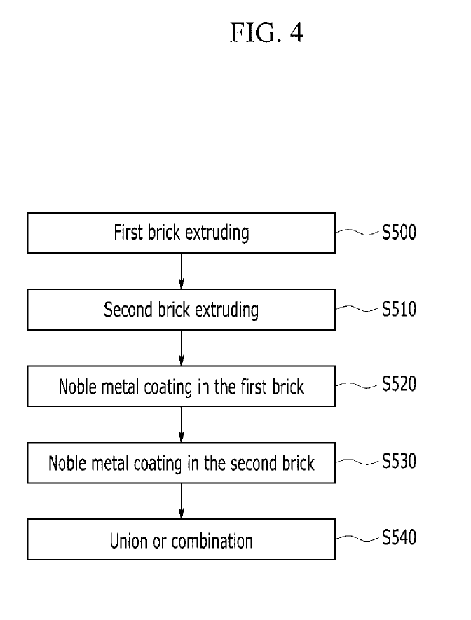

FIG. 4 is a flowchart showing a manufacturing procedure of a catalyst unit according to an exemplary embodiment of the present invention.

Referring to FIG. 4, a manufacturing procedure of the catalyst unit 100 includes an extruding the first brick 102 S500, an extruding the second brick 104 S510, forming the high noble metal layer in the first brick 102 S520, forming a low noble metal layer in the second brick 104 S530, and assembling the first brick 102 with the second brick 104 S540.

In an exemplary embodiment of the present invention, the high noble metal layer is formed in the first brick 102 and the low noble metal layer is formed in the second brick 104, but it is limited thereto, the low noble metal layer is formed in the first brick 102 and the high noble metal layer is formed in the second brick 104.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For convenience in explanation and accurate definition in the appended claims, the terms “interior” and “exterior” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1-11. (canceled)

12. A manufacturing method of a catalyst unit, comprising:
extruding a first brick that exhaust gas holes are formed therein;
extruding a second brick that exhaust gas holes are formed therein;
forming a first noble metal layer in the first brick;
forming a second noble metal layer in the second brick; and
attaching the first brick on the second brick.

13. The manufacturing method of a catalyst unit of claim 12, wherein the second brick has a hole formed in the center along a longitudinal direction of the second brick to form a shape of a cylindrical pipe.

14. The manufacturing method of a catalyst unit of claim 13, wherein the first brick is inserted into the hole of the second brick and fixed there to.

15. The manufacturing method of a catalyst unit of claim 12, wherein the first brick is disposed onto an upper surface of the second brick.

16. The manufacturing method of a catalyst unit of claim 15, wherein a lower surface of the first brick and the upper surface of the second brick have a curved line surface.

17. The manufacturing method of a catalyst unit of claim 16, wherein a central portion of the lower surface in the first brick is plane and both side edges thereof are slanted upwards and a central portion of the upper surface of the second brick is plane corresponding to the lower surface of the first brick and both sides edges thereof are slanted upwards.
